(19) United States
(12) Patent Application Publication
(10) Pub. No.: US 2021/0022014 A1
(43) Pub. Date: Jan. 21, 2021

(54) SYSTEM AND METHOD FOR SELECTING A FREQUENCY TO BOOST IN A REPEATER

(71) Applicant: Nextivity, Inc., San Diego, CA (US)

(72) Inventor: Michiel Petrus Lotter, San Diego, CA (US)

(21) Appl. No.: 16/932,442

(22) Filed: Jul. 17, 2020

Related U.S. Application Data
(60) Provisional application No. 62/876,008, filed on Jul. 19, 2019.

(51) Int. Cl. H04W 16/26; H04B 7/155; H04W 48/18

(52) U.S. Cl. CPC H04W 16/26; H04W 48/18; H04B 7/15507; H04B 7/15542

(57) ABSTRACT

A method includes receiving, at a wireless signal booster, wireless signals on two or more frequencies; interrogating, by the wireless signal booster, a mobile device to retrieve a frequency of operation of the mobile device, the mobile device connected to the wireless signal booster using a first wireless communication connection, the mobile device connected to a network using the second wireless communication, wherein the mobile device provides a frequency of the network in response to interrogation by the wireless signal booster; selecting, based on the retrieved frequency, one selected frequency from the two or more frequencies; and selectively boosting, by the wireless signal booster, the wireless signals of the selected frequency, the selectively boosting repeating the wireless signals from the selected frequency in a boosted state for a mobile phone recipient. Related systems, apparatus, articles, and techniques are also described.

### CROSS-REFERENCE TO RELATED APPLICATONS

The present application claims the benefit of U.S. Provisional Application No. 62/876,008, filed Jul. 19, 2019, and entitled “SYSTEM AND METHOD FOR SELECTING A FREQUENCY TO BOOST IN A REPEATER”, the entire contents of which are incorporated herein by reference.

### BACKGROUND

Wireless repeaters can be divided into two broad classes: namely, Wideband Boosters that boost the signal from more than one mobile phone operator at any point in time through the use of a broadband amplifier; and Provider Specific Signal Boosters (also known as channel select repeaters) that filter out the signal of a specific mobile operator and boost only that signal.

For the case of Provider Specific Signal Boosters, the selection of which operator's signal to boost can be made in a number of different ways. Typically, Provider Specific or Channel Select boosters can be re-programmed to boost the signal of a different mobile phone operator to the one that is currently assigned. Normally, this is done by connecting a computer to the repeater via an interface such as a USB interface, and downloading new software to the booster. Typically, a special software release is provided by the repeater vendor and the user can then program the repeater with this special software version.

### SUMMARY

In this disclosure, systems and methods to change a configuration of a booster are described.

In an aspect, a method includes receiving, at a wireless signal booster, wireless signals on two or more frequencies; interrogating, by the wireless signal booster, a mobile device to retrieve a frequency of operation of the mobile device, the mobile device connected to the wireless signal booster using a first wireless communication connection, the mobile device connected to a network using the second wireless communication, wherein the mobile device provides a frequency of the network in response to interrogation by the wireless signal booster; selecting, based on the retrieved frequency, one selected frequency from the two or more frequencies; and selectively boosting, by the wireless signal booster, the wireless signals of the selected frequency, the selectively boosting repeating the wireless signals from the selected frequency in a boosted state for a mobile phone recipient.

In another aspect, a system and method includes receiving, at a wireless signal booster, wireless signals on two or more frequencies. The system and method further includes operations for interrogating, by the wireless signal booster, a mobile device to retrieve a frequency of operation of the mobile device, the mobile device being connected to the wireless signal booster using a first wireless communication connection, the mobile device being connected to a network using a second wireless communication, and the mobile device providing a frequency of the network in response to the interrogating by the wireless signal booster. The system and method further includes operations for selecting, based on the retrieved frequency, one selected frequency from the two or more frequencies, and selectively boosting, by the wireless signal booster, the wireless signals of the selected frequency from the two or more frequencies, the selectively boosting repeating the wireless signals from the selected frequency in a boosted state for a wireless signal recipient device.

One or more of the following features can be included in any feasible combination. For example, the method can include retrieving a booster configuration information from a memory storing booster configuration information for at least two frequencies. The booster can include the memory. The memory can be at a location remote from the booster. The mobile device can include the memory. The wireless signal booster can periodically retrieve the frequency of operation of the mobile device from the mobile device.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a system and method where the booster interrogates an external device to retrieve its required configuration; and

FIG. 2 illustrates a multi-stage information retrieval process where more than one step is needed to retrieve the frequency information.

Like reference symbols in the various drawings indicate like elements.

### DETAILED DESCRIPTION

This document describes systems and methods to change a configuration of a booster. The booster can be a wireless signal booster that can operate in accordance with any of a number of wireless communication protocols or technologies. For instance, the booster can be included in a wireless repeater, and can include a gain amplifier. A system and method can include a booster connected with a communication network. In accordance with some implementations, the signal to be boosted can be selected from multiple frequencies. In exemplary implementations, a system interrogates an external device to retrieve the external device's configuration. The configuration can be required, i.e. based on operational capabilities of the external device, quality of service (QoS) requirements, availability requirements, etc. The system can interrogate the external device to receive one or more frequencies that are each associated with one of several available configurations to which the booster can be reconfigured. This information is then used to automatically configure the booster for operation on the network associated with the frequency.

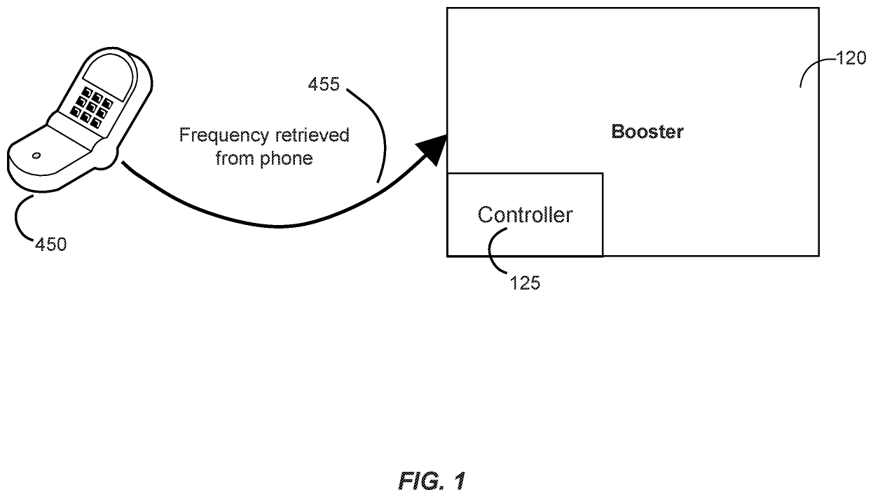

FIG. 1 illustrates a system and method 100 where the booster 120 interrogates 455 an external device 450 to retrieve its required configuration. The interrogation 455 can be done using a wireless signal transmitted from the booster 120 to the external device 450 via the network, and/or receiving a wireless signal by the booster 120 from the external device 450. The booster 120 includes a controller 125 to receive and analyze the interrogation. The booster 120 can be included in a wireless repeater, for example. The external device 450 can be a mobile phone, a mobile computing device such as a laptop computer, tablet computer, or the like, or other mobile computing device such as a hand-held mobile device or wearable computing device such as a smart watch.

The controller 125 on the booster 120 can interrogate the external device 450 and in turn retrieve a frequency of operation of the mobile device from the external device 450. The controller 125 can use the frequency to obtain configuration information. The configuration information can be stored on the booster itself 120 or the information can be stored externally, such as in a computing cloud. Once the controller 125 has the configuration information, the controller 125 can use the information associated with the frequency to configure the booster 120 appropriately, in which the booster 120 can be made to conform to the configuration parameters for the frequency associated with the external device.

In alternative implementations, the frequency of the required network is retrieved from an external device and the configuration is then retrieved either from a local storage on the booster or from a remote location, such as a cloud storage or other network-based storage.

In yet other implementations, the frequency of the network is periodically retrieved from a connected device to ensure that the correct network is always boosted. For example, if the booster 120 is in a car or other vehicle, the booster 120 may travel across an international boundary, causing the external device 450, if a mobile phone, to go into roaming mode, and requiring the booster to automatically reconfigure itself for the new network onto or into which the external device 450 has geographically roamed.

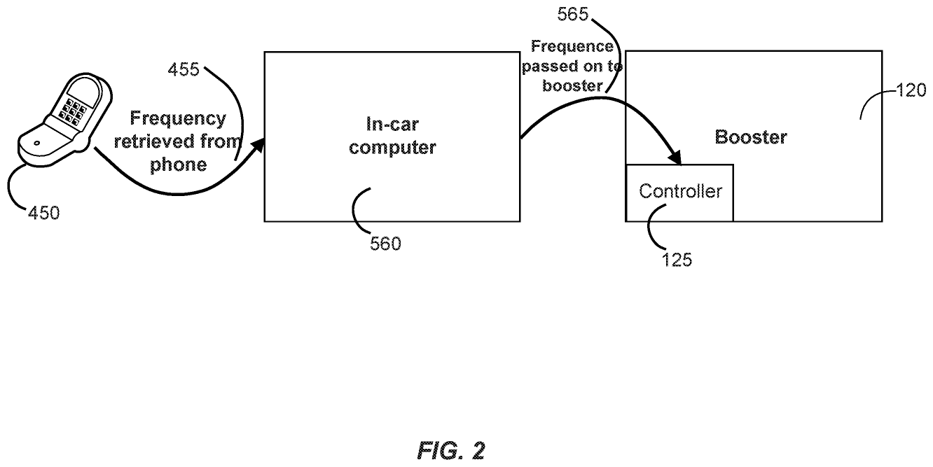

FIG. 2 illustrates a multi-stage information retrieval process 200 where more than one step is needed to retrieve the frequency information. For example, the booster 120 may be installed in a car or other vehicle, and the external device 450 is a driver's mobile phone that is synched with an in-car computer 560. When the external device 450 synchronizes with the in-car computer 560, the frequency can be retrieved by interrogation 455 of and from the external device 450. The controller 125 associated with the booster 120 can then retrieve 565 the frequency to be boosted from the in-car computer 560, which in turn retrieves this information from the phone 450.

In accordance with some implementations, a sub-configuration of the external device 450 and/or network can be retrieved by the system. Under some conditions, for example when a booster is directly connected to a machine-to-machine (M2M) module, it is not required to boost all the frequencies of an operator. In this case, in addition to retrieving the frequency and configuration of the booster, a sub-configuration can be retrieved to allow the booster to only boost the frequencies actually in use by the M2M module, as opposed to all the frequencies on which the signal is broadcasted.

Although a few embodiments have been described in detail above, other modifications are possible. Other embodiments may be within the scope of the following claims.

What is claimed is:

1. A method comprising:
receiving, at a wireless signal booster, wireless signals on two or more frequencies;
interrogating, by the wireless signal booster, a mobile device to retrieve a frequency of operation of the mobile device, the mobile device being connected to the wireless signal booster using a first wireless communication connection, the mobile device being connected to a network using a second wireless communication, and the mobile device providing a frequency of the network in response to the interrogating by the wireless signal booster;
selecting, based on the retrieved frequency, one selected frequency from the two or more frequencies; and
selectively boosting, by the wireless signal booster, the wireless signals of the selected frequency from the two or more frequencies, the selectively boosting repeating the wireless signals from the selected frequency in a boosted state for a wireless signal recipient device.

2. The method of claim 1, further comprising:
retrieving booster configuration information from a memory storing booster configuration information for at least two frequencies of the two or more frequencies.

3. The method of claim 2, wherein the wireless signal booster includes the memory.

4. The method of claim 2, wherein the memory is remote from the booster and connected to the booster by a communication network.

5. The method of claim 2, wherein the mobile device includes the memory.

6. The method of claim 1, wherein the wireless signal booster periodically retrieves the frequency of operation of the mobile device from the mobile device.

7. A system comprising:
a wireless signal booster configured to receive wireless signals on two or more frequencies; interrogate a mobile device to retrieve a frequency of operation of the mobile device, the mobile device connected to the wireless signal booster using a first wireless communication connection, the mobile device connected to a network using a second wireless communication, wherein the mobile device provides a frequency of the network in response to interrogation by the wireless signal booster; select, based on the retrieved frequency, a selected frequency from the two or more frequencies; and selectively boost, by the wireless signal booster, the wireless signals of the selected frequency, the selectively boosting repeating the wireless signals from the selected frequency in a boosted state for a wireless signal recipient.

8. The system of claim 7, the wireless signal booster is further configured to retrieve a booster configuration information from a memory that stores booster configuration information for at least two frequencies.

9. The system of claim 8, wherein the wireless signal booster includes the memory.

10. The system of claim 8, wherein the memory is remote from the booster.

11. The system of claim 8, wherein the mobile device includes the memory.

12. The system of claim 7, wherein the wireless signal booster is configured to periodically retrieve the frequency of operation of the mobile device from the mobile device.
